(19) United States
(12) Patent Application Publication
(10) Pub. No.: US 2004/0036903 A1
(43) Pub. Date: Feb. 26, 2004

(54) Printing apparatus

(75) Inventor: Osamu Azami, Nagano (JP)

Correspondence Address: SUGHRUE MION, PLLC, 2100 PENNSYLVANIA AVENUE, N.W., WASHINGTON, DC, 20037, US

(73) Assignee: SEIKO EPSON CORPORATION

(21) Appl. No.: 10/453,890

(22) Filed: Jun. 4, 2003

(30) Foreign Application Priority Data
Jun. 4, 2002 (JP) P2002-162638

(51) Int. Cl. B41F 1/00; G06F 15/00

(52) U.S. Cl. 358/1.13; 358/1.15

(57) ABSTRACT

A printing apparatus that performs so-called pull printing based on print content defining information specified by a print content defining information name is arranged in such a manner that the user can specify a print condition at the time of printing (the paper size, the resolution, and the number of sets) and that the user can set a pre-selected time for printing.

The present application is based on Japanese Patent Application No. 2002-162638, which is incorporated herein by reference.

### BACKGROUND OF THE INVENTION

1. Field of the Invention

The present invention relates to a printing apparatus for use on a computer network.

2. Description of the Related Art

A printing apparatus generally used as peripheral equipment of a computer is an apparatus that activates upon receipt of print data containing all the information needed for printing. Recently, however, there has been developed a printing apparatus with the capability to perform printing upon receipt of only a URL of a Web page or a PDF file.

Printing performed on the printing apparatus by actively acquiring necessary data by itself as described above is generally referred to as pull printing.

It is not necessary for a host apparatus to generate print data in allowing the printing apparatus to perform pull printing. Hence, once a printing apparatus with the capability to perform pull printing is prepared, a PDA (Personal Digital Assistant) or the like, which cannot generate print data due to a limited capacity of an installed memory or the like (which cannot be used with a printing apparatus without the capability to perform pull printing), is allowed to function as an apparatus through which printing can be performed. Also, load on a normal computer at the time of printing can be reduced.

However, the pull printing function furnished to the existing printing apparatus is a function of printing Web pages or PDF files open to the public in a straightforward manner.

### SUMMARY OF THE INVENTION

Therefore, it is an object of the invention to provide a printing apparatus with the capability to perform pull printing and to produce a printing result in a manner the user desires.

In order to achieve the above and other objects, a printing apparatus of the invention for use on a computer network includes: communication means for enabling communications with apparatuses included in the computer network; and print execution means for, upon receipt of a processing execution request containing image defining information specifying data specifying image defining information convertible to an image through the use of one or more than one item of data retained in the apparatuses constructing the computer network, and print condition defining data defining a print condition of the image based on the image defining information, acquiring, from the computer network via the communication means, data needed to convert the image defining information into the image, based on the image defining information specified by the image defining information specifying data contained in the processing execution request, and performing printing according to the print condition indicated by the print condition defining data contained in the processing execution request for the image based on the image defining information, using respective acquired data.

As has been described, the printing apparatus of the invention is an apparatus that performs so-called pull printing based on the image defining information specified by the image defining information specifying data, and operates as an apparatus to which the print condition at the time of printing (for example, the paper size, the resolution, color/monochrome, and the number of sets) can be specified. For this reason, even in a case where the image defining information specified by the image defining information specifying data set by the user (sent to the printing apparatus) is the same, when the print condition specifying data set by the user is different, the printing apparatus functions as an apparatus through which different print results can be obtained. In other words, it functions as an apparatus through which a print result can be obtained in a manner the user desires.

When the printing apparatus of the invention is achieved, any format can be used for the image defining information. In other words, for example, typically used format, such as the HTML data, may be used as the image defining information, or alternatively, the data of its own format may be used. Also, when the printing apparatus of the invention is achieved, all the image defining information may be acquired from the computer network, or the image defining information may be saved in the printing apparatus either partly or entirely.

Further, the printing apparatus of the invention may further include: data storage means for storing data; and data storage control means for controlling the data storage means to store the data acquired by the print execution means. Also, the printing apparatus of the invention may adopt, as the print execution means, means for not acquiring data from the computer network in regard to of all the data that needs to be acquired, respective data stored in the storage means, and instead using the data stored in the storage means. In other words, the printing apparatus of the invention may be achieved by providing an additional data-cashing function.

Also, the printing apparatus of the invention may further include thumbnail data returning means for, upon receipt of a thumbnail request containing image defining information specifying data specifying image defining information convertible to an image through the use of one or more than one item of data retained in the apparatuses constructing the computer network, and print condition defining data defining a print condition of the image based on the image defining information, acquiring, from the computer network via the communication means, data needed to convert the image defining information specified by the image defining information specifying data contained in the thumbnail request into the image, then generating thumbnail data related to a print result to be generated by the print execution means upon receipt of a processing execution request corresponding to the thumbnail request, and returning the thumbnail data to an apparatus that has sent the thumbnail request, via the communication means.

The printing apparatus adopting such an arrangement functions as an apparatus that allows the user to confirm the content before printing is actually performed.

The printing apparatus of the invention may be achieved by making the processing execution request as a request containing start condition specifying data specifying a condition to start printing, and by using, as the print execution means, means for receiving the processing execution request via the communication means, and then performing printing of a content specified by the processing execution request when the condition indicated by the start condition specifying data contained in the processing execution request is satisfied.

By adopting such an arrangement, for example, it is possible to achieve a printing apparatus with the capability to perform printing at a specified time, to perform printing according to a specified schedule, and to perform printing each time data needed to convert the image defining information into an image is updated.

Features and advantages of the invention will be evident from the following detailed description of the preferred embodiments described in conjunction with the attached drawings.

### BRIEF DESCRIPTION OF THE DRAWINGS

In the accompanying drawings:

FIG. 1 is an explanatory view showing the mode of usage of a printing apparatus according to one embodiment of the invention;

FIG. 2 is a view showing a hardware configuration of the printing apparatus of the embodiment;

FIG. 3 is a flowchart detailing an overall operation procedure of a control portion in the printing apparatus of the embodiment;

FIG. 4 is a flowchart detailing pull printing control processing performed by the control portion in the printing apparatus of the embodiment;

FIG. 5 is an explanatory view of a job-managing table retained in the printing apparatus of the embodiment;

FIG. 6 is an explanatory view showing a screen displayed on a PDA having installed a printing apparatus access program; and

FIG. 7 is an explanatory view of pull printing performed by the printing apparatus of the embodiment.

### DETAILED DESCRIPTION OF THE PREFERRED EMBODIMENTS

The following description will describe in detail an embodiment of the invention with reference to the accompanying drawings.

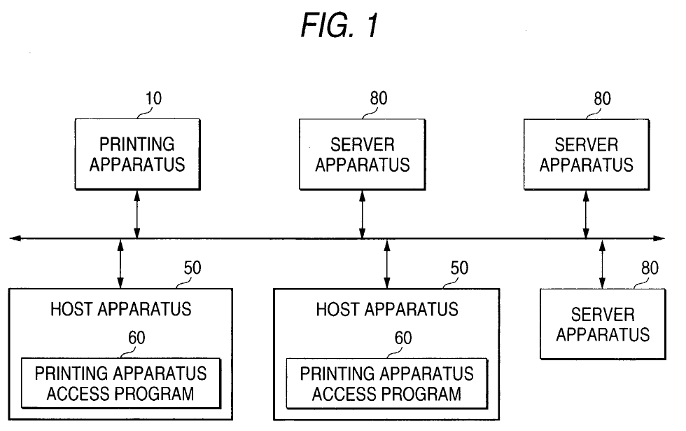

Firstly, a general description and the mode of usage of a printing apparatus according to one embodiment of the invention will be explained with reference to FIG. 1.

A printing apparatus 10 of this embodiment is a printer with the capability to perform so-called pull printing in addition to normal printing (printing based on print data), and is used in a configuration in which it is linked to a computer network including one or more than one server apparatus 80 and more than one host apparatus 50 (typically, in a configuration in which it is linked to a LAN including an internet router). The host apparatus 50 referred to herein is defined as a computer through the use of which the printing apparatus 10 is used. A computer having installed a printing apparatus access program 60 is used as the host apparatus 50. Although the function of the printing apparatus access program 60 will be described below, a version to be installed in a typical computer and a version to be installed in a PDA or the like having a reduced ability in comparison with the typical computer are prepared as the printing apparatus access program 60. The server apparatus 80 referred to herein is defined as a computer furnished with a function of retaining data available for pull printing and sending the data to a request sender according to protocols, such as ftp and http (so-called ftp server, http server, etc.). FIG. 1 shows a case where the host apparatuses 50 and the server apparatuses 80 are provided independently; however, there may be a case that a single apparatus functions as both the host apparatus 50 and the server apparatus 80.

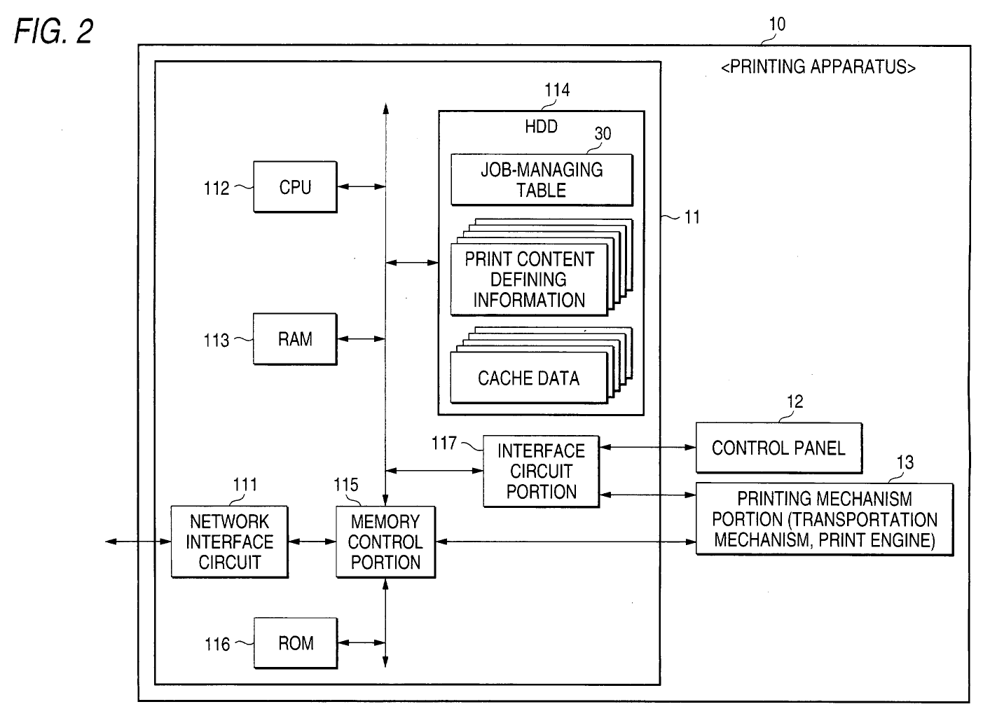

A hardware configuration of the printing apparatus 10 will now be explained with reference to FIG. 2.

As shown in the drawing, the printing apparatus 10 includes a control portion 11, a control panel 12, and a printing mechanism portion 13.

The control panel 12 is a unit provided to the printing apparatus 10 as an interface between the user and the printing apparatus 10. The control panel 12 is composed of a plurality of buttons pressed by the user, a plurality of LEDs indicating an operating status of the printing apparatus 10, and a liquid crystal display on which various messages are displayed.

The printing mechanism portion 13 is a mechanism that performs printing on a sheet of paper under the control of the control portion 11. The printing mechanism portion 13 is composed of a print engine that actually performs printing on a sheet of paper, and a mechanism (paper-feeding device, paper-discharging device, etc.) that feeds the print engine with a sheet of paper and discharges a sheet of paper done with printing to the outside of the printing apparatus 10.

The control portion 11 is a unit that controls the printing mechanism portion 13 to perform printing. The control portion 11 is composed of a network interface circuit 111, a CPU 112, a RAM 113, an HDD 114, a memory control portion 115, a ROM 116, and an interface circuit portion 117, etc.

The network interface circuit 111 is a circuit enabling communications according to TCP/IP. The ROM 116 is a non-volatile memory having stored programs and font data. The CPU 112 is a control circuit that controls all the portions inside the control portion 11 in an orchestrated manner according to a program loaded on the RAM 113 from the ROM 116, by using a program-unloaded area in the memory region of the RAM 113 as a work area.

The HDD 114 is an auxiliary storage device for storing (saving) a job-managing table 30, print content defining information, cache data, etc. The job-managing table 30, the print content defining information, cache data, etc. stored in the HDD 114 will be described in detail below.

The memory control portion 115 is a circuit that performs processing to transmit data from the network interface circuit 111 to the RAM 113, processing to transmit print data generated on the RAM 113 to the print engine inside the printing mechanism portion 13, etc. at a command from the CPU 112. The interface circuit portion 117 is a circuit that the CPU 112 uses when controlling the control panel 12 and the respective devices inside the printing mechanism portion 13, and is composed of more than one interface circuit enabling data transmission between the CPU 112 and the control panel 12, between the CPU 112 and a transportation mechanism in the printing mechanism portion 13, etc.

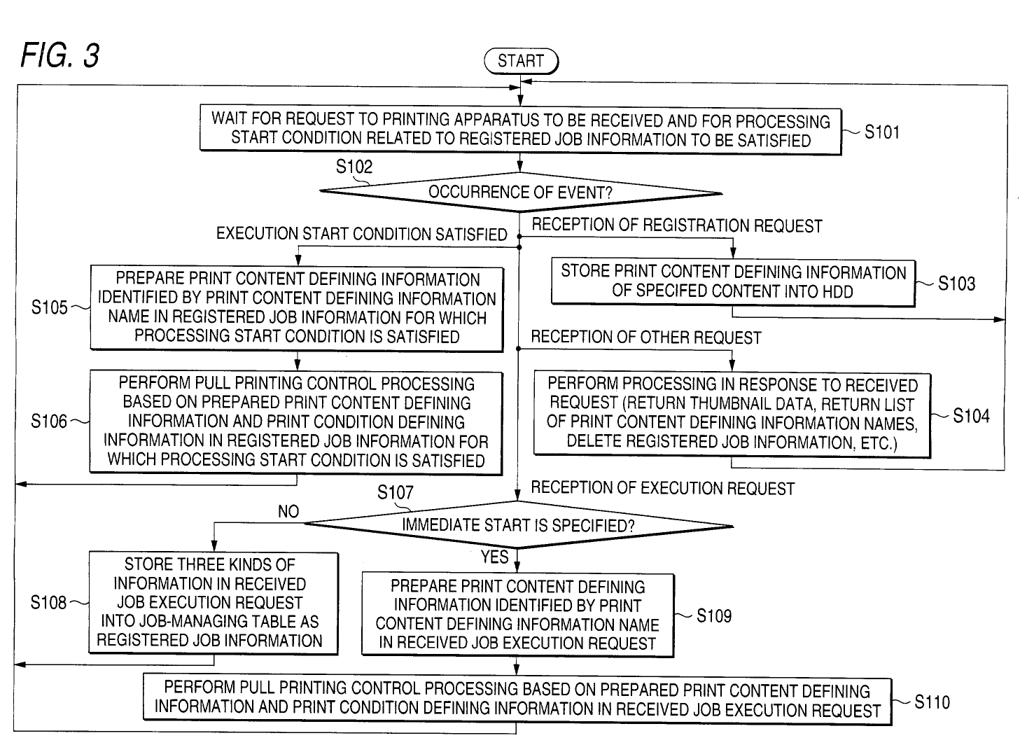

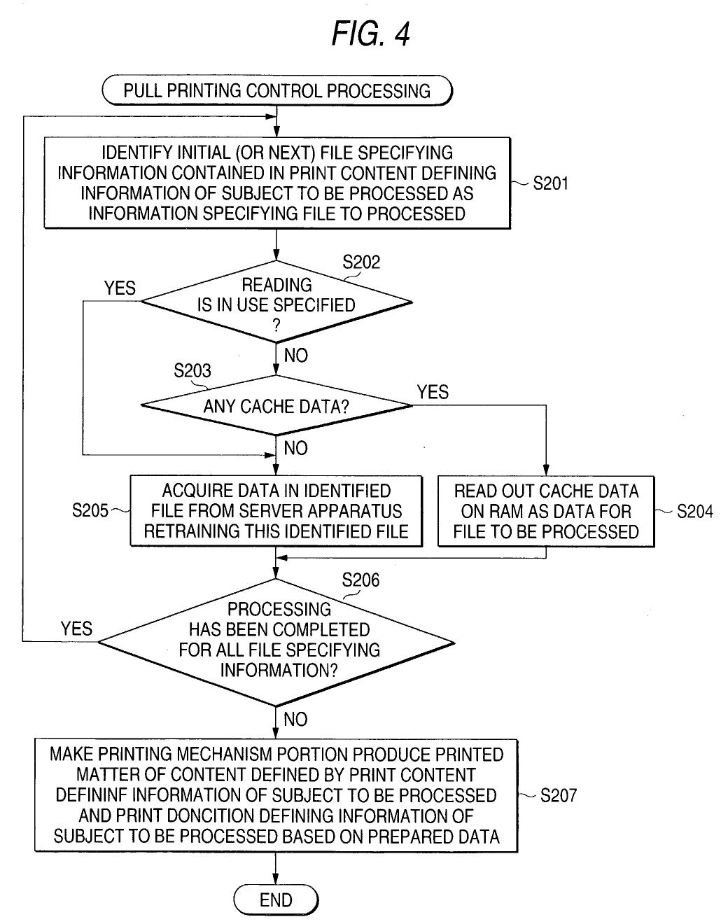

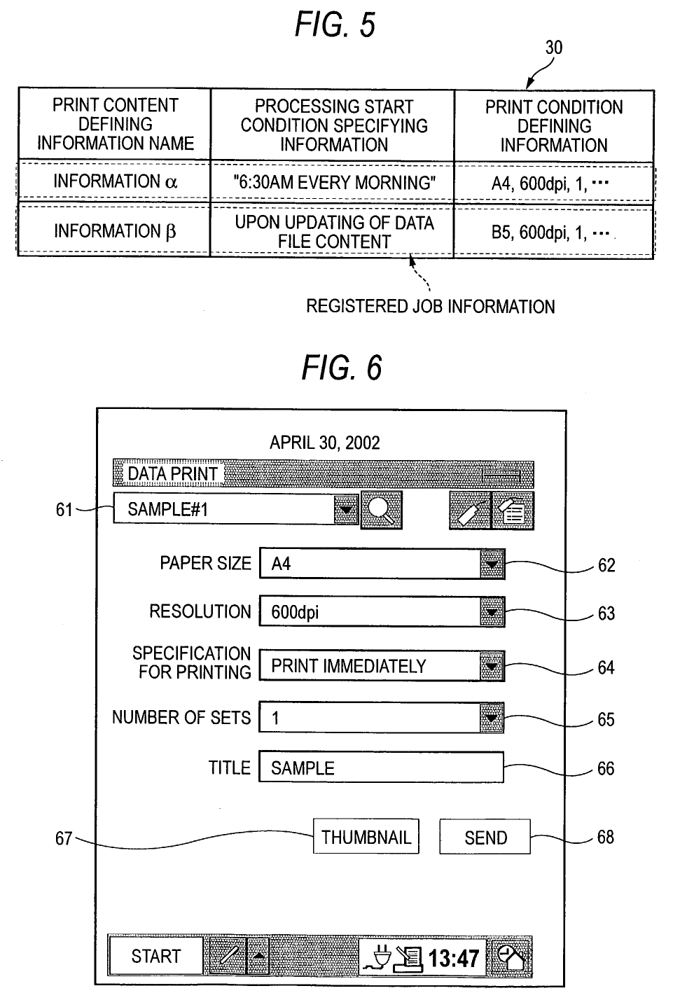

The pull printing function furnished to the printing apparatus 10 will now be explained with reference to FIG. 3 through FIG. 5. Of these drawings, FIG. 3 is a flowchart detailing an overall operation procedure of the control portion 11 after the power is supplied to the printing apparatus 10. It should be noted, however, that this flowchart omits a description of an operation procedure and the like of the control portion 11 for normal printing. Also, FIG. 4 is a flowchart detailing pull printing control processing performed in Steps S106 and S110 of FIG. 3, and FIG. 5 is an explanatory view of the job-managing table 30.

The pull printing control processing is defined as processing by which printed matter is actually produced when performed. Also, the pull printing control processing is the processing performed after print content defining information and print condition defining information, which are the subject to be processed, are determined (processing performed when the print content defining information and the print condition defining information are given as parameters).

The print content defining information referred to herein is defined as information containing more than one set of file specifying information (a server name and a full path file name) specifying a file retained in any of the server apparatuses 80 or owned by the printing apparatus 10, and use method specifying information specifying a use method (a layout method on a sheet of paper, transparent/non-transparent, etc.) as to how the data in the file specified by the file specifying information is used for printing. The print content defining information is also the information that optionally contains paper size specifying information specifying the size of paper used for printing (information that does not have to contain the paper size specifying information). Further, the print content defining information is the information that optionally contains information specifying reading in use that specifies cache data (described in detail below) is not used for part of file specifying information (data is invariably read out at the time of printing regardless of the presence or absence of the cache data). The printing apparatus 10 is an apparatus that handles data of its own format and so-called HTML data as the print content defining information.

Meanwhile, the print condition defining information (print condition defining data) is defined as information specifying a print condition, including the size of paper, the number of sets, the resolution, etc. (a condition that can be set in a so-called property dialog box of the printer). The print condition defining information is the information optionally containing a character string for print with insertion. The character string for print with insertion is defined as a character string to be set in an insertion field in a form file in a case where the file specifying information specifying the form file having the insertion field is contained in the print content defining information.

The pull printing control processing is the processing performed according to the procedure shown in FIG. 4 based on the foregoing print content defining information and print condition defining information.

To be more specific, when the pull printing control processing is performed, the control portion 11 first identifies the initial file specifying information contained in the print content defining information, which is the subject to be processed, as the information specifying a file to be processed (Step S201). Then, the control portion 11 judges whether reading in use is specified to the file identified by the information specifying a file to be processed (hereinafter, referred to as the file to be processed) (whether the print content defining information of the subject to be processed contains information specifying reading in use, indicating the need of reading in use) (Step S202). In a case where the reading in use is not specified to the file to be processed (NO in Step S202), the control portion 11 judges whether cache data related to the file to be processed is stored in the HDD 114 (Step S203). When the cache data is present (YES in Step S203), the control portion 11 reads out the cache data from the HDD 114 on the RAM 113 as the data related to the file to be processed (Step S204).

On the other hand, when the cache data related to the file to be processed is not stored in the HDD 114 (NO in Step S203), or when the reading in use is specified to the file to be processed (YES in Step S202), the control portion 11 proceeds to Step S205 and performs processing to acquire the file to be processed from the server apparatus 80 retaining the file to be processed based on the information specifying a file to be processed (downloads and stores the file to be processed on the RAM 113). Also, in Step S205, the control portion 11 performs processing to store the data thus acquired into the HDD 114 as cache data.

Although it is not shown in the flowchart of the drawing, in a case where the information specifying a file to be processed specifies a file stored in the HDD 114, the control portion 11 performs processing to read out this particular file from the HDD 114 on the RAM 113 instead of the processing from Steps S202 through S205 (in this case, neither the data is cached nor whether reading in use is specified or unspecified and the presence or absence of the cache data are judged).

When data related to the file to be processes is ready on the RAM 113 through the processing in Step S204 or S205 or by being read out from the HDD 114, the control portion 11 judges whether processing is completed for all the file specifying information (Step S206). Then, when the processing is not completed for all the file specifying information (NO in Step S206), the control portion 11 performs the processing from Step S201 for the following file specifying information.

On the other hand, when the processing has been completed for all the file specifying information (YES in Step S206), the control portion 11 proceeds to Step S207 and performs processing to control the printing mechanism portion 13 to produce printed matter (printed matter in one or more than one sheet of paper according to the specified paper size, resolution, number of sets, etc.) of the content defined by both the print content defining information of the subject to be processed (sets of use method specifying information contained therein) and the print condition defining information of the subject to be processed based on the respective prepared data.

In a case where the paper size specifying information is contained in the print content defining information, the control portion 11 performs, in Step S207, processing to control the printing mechanism portion 13 to produce printed matter on which scaling is effected to bring the content indicated by the print content defining information in agreement with the size of paper specified by the print condition defining information of the subject to be processed. Also, in a case where a form file is specified as a file to be used (a file identified by the file specifying information in the print content defining information), the control portion 11 performs processing to control the printing mechanism portion 13 to produce printed matter in which a character string contained in the print condition defining information of the subject to be processed is set in an insertion field of the form file.

Having completed the foregoing processing, the control portion 11 ends the pull printing control processing.

An overall operation of the control portion 11 will now be explained with reference to FIG. 3.

As is obvious from the drawing, in a normal state, the control portion 11 performs processing to wait (monitor) for various requests to be sent and for a processing start condition related to registered job information to be satisfied in Step S101. The registered job information referred to herein is defined as information stored in the job-managing table 30 (details of which will be described below), and in a case where the registered job information is not stored in the job-managing table 30, the control portion 11 performs processing only to monitor transmission of various requests in Step S101.

Although the function of the host apparatus 50 (printing apparatus access program 60) will be described below, the host apparatus 50 transmits a print content defining information registration request, a job execution request, a print content defining information name request, a thumbnail request, a registered job information delete request, etc. to the printing apparatus 10.

Of these requests, the print content defining information registration request is a request that contains information specifying the content of the print content defining information to be stored in the HDD 114, and a name given to this particular print content defining information (hereinafter, referred to as the print content defining information name).

Upon receipt of the print content defining information registration request (reception of registration request in Step S102), the control portion 11 stores the print content defining information of the content specified by the received print content defining information registration request into the HDD 114 in an identifiable manner with the print content defining information name specified by the print content defining information registration request (Step S103). Subsequently, the control portion 11 starts the processing in Step S101 again.

Also, the job execution request is a request to direct the printing apparatus 10 (control portion 11) to perform the pull printing control processing. The job execution request is a request that specifies not only the content of the pull printing control processing to be performed, but also the processing start condition.

To be more concrete, the job execution request contains the print content defining information name and the print condition defining information as the information specifying the content of the pull printing control processing to be performed, and contains processing start condition specifying information as the information specifying the processing start condition. Also, the job execution request can be set with not only the name of the print content defining information in the HDD 114, but also a URL of a Web page, a URL of the print content defining information retained in any of the server apparatuses 80, etc. as the print content defining information name, and it is a request in which information as follows can be set as the processing start condition specifying information: information specifying to start the pull printing control processing immediately; information specifying to perform printing once at a specified time or more than once according to a specified schedule; information specifying to perform printing each time the content of a file to be used (the file identified by the file specifying information in the print content defining information) is updated, etc.

Upon receipt of the job execution request (reception of execution request in Steps S101 and S102), the control portion 11 judges whether the received job execution request specifies to immediately start the pull printing control processing (whether it contains the processing start condition specifying information specifying an immediate start) (Step S107). When the immediate start is specified (YES in Step S107), the control portion 11 reads out the print content defining information identified by the print content defining information name contained in the job execution request from the HDD 114 on the RAM 113 (Step S109). In a case where a URL of a Web page is given as the print content defining information name, the control portion 11 acquires the Web page (HTML data) identified by the URL and stores the same on the RAM 113 as the print content defining information in Step S109. Alternatively, in a case where a URL of the print content defining information retained in any of the server apparatuses 80 is given as the print content defining information name, the control portion 11 acquires the print content defining information identified by the URL from the server apparatus 80 and stores the same on the RAM 113.

Subsequently, the control portion 11 proceeds to Step S110 and performs the pull printing control processing, of which content has been described above, based on the print content defining information prepared on the RAM 113 and the print condition defining information contained in the received job execution request (the pull printing control processing using these two kinds of information as the subject to be processed).

On the other hand, when the received job execution request does not specify to start the pull printing control processing immediately (NO in Step S107), the control portion 11 stores information composed of three kinds of information contained in this job execution request into the job-managing table 30 arranged as shown in FIG. 5 as the registered job information (Step S108). Subsequently, the control portion 11 starts the processing in Step S101.

In a case where more than one registered job information is stored in the job-managing table 30, the control portion 11 also performs processing in Step S101 to monitor for which registered job information in the job-managing table 30 the processing start condition is satisfied.

To be more concrete, for the respective registered job information to which the processing start date and hour is specified, the control portion 11 performs processing to monitor whether a condition that the processing start date and hour agrees with the current date and hour is satisfied. Also, for the respective registered job information to which printing upon updating of data (printing is performed each time the content of a file to be used is updated) is specified, the control portion 11 performs processing to prepare the print content defining information identified by the print content defining information name in the registered job information on the RAM 113 at predetermined cycles (a cycle specified by the user through a manipulation of the control panel 12, etc.), and then to check whether the file to be used is updated based on the print content defining information in judging whether the processing start condition is satisfied.

Upon detection that the processing start condition related to any of the registered job information is satisfied (processing start condition satisfied in Step S101 and S102), the control portion 11 prepares the print content defining information identified by the print content defining information name in the registered job information on the RAM 113 (Step S105). In this step, however, the processing to prepare the print content defining information on the RAM 113 is actually performed only when the printing upon updating of data is not specified in the registered job information for which the processing start condition is satisfied (in a case where the printing upon updating of data is specified in the registered job information for which the processing start condition is satisfied, the print content defining information is already read out on the RAM 113 to check whether the file to be used is updated or not).

Then, the control portion 11 proceeds to Step S106, and performs the pull printing control processing based on the print content defining information thus prepared and the print condition defining information in the registered job information for which the processing start condition is satisfied.

Upon completion of the processing in Step S106, in a case where printing has to be performed only once for the registered job information that has been printed, the control portion 11 deletes the registered job information from the job-managing table 30 (not shown). Subsequently, the control portion 11 starts the processing in Step S101.

The print content specifying informant name request occasionally sent to the printing apparatus 10 from the host apparatus 50 is a request containing no parameter. Upon receipt of the print content defining information name request (other request in Steps S101 and S102), the control portion 11 proceeds to Step S104 and performs processing to return the information containing the names of all the print content defining information (print content defining information names) stored in the HDD 114 to the host apparatus 50 that has sent the print content defining information name request, and then starts the processing in Step S101.

The thumbnail request is a request containing a processing content defining information name and the paper size specifying information. Upon receipt of the thumbnail request (other request in Steps S101 and S102), the control portion 11 proceeds to Step S104, and generates thumbnail data indicating a print result (low-resolution image data of the print result) by performing processing according to substantially the same procedure of the pull printing control processing (a step corresponding to Step S202 is omitted and thumbnail data is generated and returned in a step corresponding to Step S207), and performs processing to return the thumbnail data to the apparatus that has sent the thumbnail request. Subsequently, the control portion 11 starts the processing in Step S101.

The registered job information delete request is a request containing the processing content defining information name. Upon receipt of the registered job information delete request (other request in Steps S101 and S102), the control portion 11 proceeds to Step S104 and performs processing to delete from the HDD 114 the processing content defining information identified by the processing content defining information name contained in the request, after which it starts the processing in Step S101.

The printing apparatus access program 60 will now be explained.

As has been described, the printing apparatus access program 60, which is a program needed when the printing apparatus 10 is used, includes a version for a typical computer and a version for a PDA or the like. Of these programs, the printing apparatus access program 60 prepared as the version for a typical computer is a type of DTP/document creation program that enables the user to specify a file to be used and a use method of the file to be used for printing in the WYSIWYG format. Also, the printing apparatus access program 60 is furnished with a function of sending all kinds of the foregoing requests to the printing apparatus 10.

On the other hand, the printing apparatus access program 60 prepared to be installed in a PDA or the like is a program that furnishes a computer with a transmission function for only a print content defining information name request, a thumbnail request, and a job execution request.

To be more concrete, in the case of a PDA having installed the printing apparatus access program 60, when the printing apparatus access program 60 is activated, the PDA performs processing to send the print content defining information name request to the printing apparatus 10. Then, the PDA performs processing to display information on the screen as shown in the drawing based on the information returned from the printing apparatus 10 in response to the print content defining information name request.

A print content defining information name setting column 61 on the screen is a dropdown list combo box (control that allows choice of options through input of characters and on a list of options) in which the user sets the print content defining information name. The information (a set of the print content defining information names) acquired from the printing apparatus 10 through transmission of the print content specifying information name request is used to determine the content of a list to be displayed when the print content defining information name setting column 61 is manipulated.

A paper size setting column 62, a resolution setting column 63, a start condition setting column 64, a number of sets setting column 65 are dropdown list boxes through which the user can set (choose) the paper size, the resolution, the processing start condition, and the number of sets, respectively. A title setting column 66 is an edit box in which the user sets a character string to be set in an insertion field within a form file when printing is performed by using the form file having the insertion field.

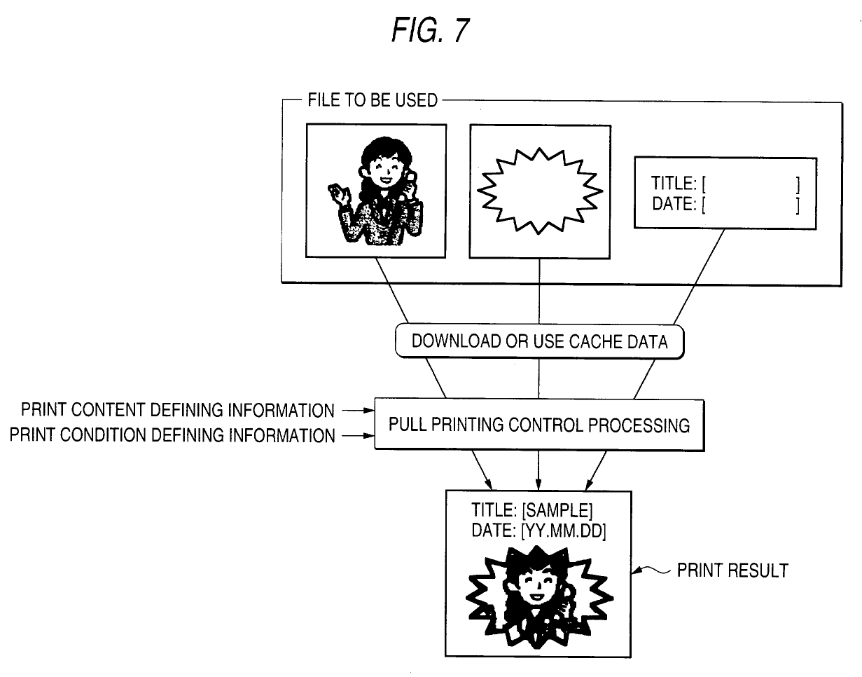

When the respective columns 61 through 66 on the screen are manipulated, the PDA performs processing to change the display content in the respective setting columns according to the content of manipulation. Also, when a thumbnail button 67 on the screen is pressed, the PDA performs processing to send a thumbnail request containing the current setting values in the print content defining information name setting column 61 and the paper size setting column 62 to the printing apparatus 10, and then performs processing to display the thumbnail data returned from the printing apparatus 10 in response to the thumbnail request. Then, when a manipulation is made to specify to terminate the display of the thumbnail data, the screen shown in FIG. 6 is displayed again, and when a send button 68 is pressed, the PDA performs processing to send a job execution request containing the respective setting values in the print content defining information name setting column 61, the paper size setting column 62, the resolution setting column 63, the start condition setting column 64, the number of sets setting column 65, and the title setting column 66 to the printing apparatus 10. For example, when the send button 68 is pressed in the state shown in the drawing, then printings of which procedure is schematically shown in FIG. 7, is performed immediately on the printing apparatus 10 at a resolution of 600 dpi.

As has been described above, the printing apparatus 10 of this embodiment is an apparatus that performs so-called pull printing based on the print content defining information (equivalent to image defining data) specified by the print content defining information name (equivalent to image defining information specifying data), and thereby operates as an apparatus to which the print condition at the time of printing (the paper size, the resolution, and the number of sets) can be specified. Hence, the user of the printing apparatus 10 can obtain a print result in the form he desired by specifying the print condition.

Also, because the printing apparatus 10 is furnished with a data-caching function, it functions as an apparatus capable of performing printing that needs data used for printing in the past at a high speed. Also, because the printing apparatus 10 is arranged in such a manner that it can return the thumbnail data, it can also function as an apparatus that allows the user to confirm the content before the printing is actually performed.

Further, the printing apparatus 10 operates as an apparatus to which the processing start condition can be specified. Hence, it is possible to achieve a printing apparatus with the capability to print a Web page or the like provided by a newspaper publishing company at a specified time, according to a specified schedule, or each time data needed to convert the image defining information into an image is updated.

<Modification>

The printing apparatus 10 described above can be modified in various manners. For example, the printing apparatus 10 was described as an apparatus capable of using the data of its own format and the HTML data as the print content defining information; however, the printing apparatus 10 may be an apparatus capable of using only data in a general format, such as the HTML data. Also, a program causing the PDA to display a screen different from the one shown in FIG. 6 may be prepared as the printing apparatus access program 60 needed when using the printing apparatus 10.

According to the invention, it is possible to achieve a printing apparatus with the capability to perform pull printing and to produce a print result in a manner the user desires.

Although the invention has been described in its preferred form with a certain degree of particularity, it is understood that the present disclosure of the preferred form can be changed in the details of construction and in the combination and arrangement of parts without departing from the spirit and the scope of the invention as hereinafter claimed.

What is claimed is:

1. A printing apparatus for use on a computer network, comprising:
communication means for enabling communications with apparatuses included in said computer network; and
print execution means for, upon receipt of a processing execution request containing image defining information specifying data specifying image defining information convertible to an image through the use of one or more than one item of data retained in the apparatuses constructing said computer network, and print condition defining data defining a print condition of the image based on the image defining information, acquiring, from said computer network via said communication means, data needed to convert the image defining information into the image, based on the image defining information specified by the image defining information specifying data contained in the processing execution request, and performing printing according to the print condition indicated by the print condition defining data contained in the processing execution request for the image based on the image defining information, using respective acquired data.

2. A printing apparatus according to claim 1, further comprising:
data storage means for storing data; and
data storage control means for controlling said data storage means to store the data acquired by said print execution means,
wherein, of all the data that needs to be acquired, said print execution means does acquire data from said computer network in regard to respective data stored in said storage means, and instead uses the data stored in said storage means.

3. A printing apparatus according to claim 1, further comprising:
thumbnail data returning means for, upon receipt of a thumbnail request containing image defining information specifying data specifying image defining information convertible to an image through the use of one or more than one item of data retained in the apparatuses constructing said computer network, and print condition defining data defining a print condition of the image based on the image defining information, acquiring, from said computer network via said communication means, data needed to convert the image defining information specified by the image defining information specifying data contained in the thumbnail request into the image, then generating thumbnail data related to a print result to be generated by said print execution means upon receipt of a processing execution request corresponding to the thumbnail request, and returning the thumbnail data to an apparatus that has sent the thumbnail request, via said communication means.

4. A printing apparatus according to claim 1,
wherein said processing execution request is a request containing start condition specifying data specifying a condition to start printing; and
said print execution means receives the processing execution request via said communication means, and then performs printing of a content specified by the processing execution request when the condition indicated by the start condition specifying data contained in the processing execution request is satisfied.
